(19) United States
(12) Patent Application Publication
(10) Pub. No.: US 2002/0153429 A1
(43) Pub. Date: Oct. 24, 2002

(54) Injection nozzle

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/937,435

(22) PCT Filed: Jan. 25, 2001
(86) PCT No.: PCT/DE01/00280

(30) Foreign Application Priority Data
Jan. 28, 2000 (DE) 100 03 863.8

(51) Int. Cl. B05B 12/10

(52) U.S. Cl. 239/75; 239/88

(57) ABSTRACT

In an injection nozzle (10) for a fuel injection system, having a pressure chamber (26) which is provided with a fluid inlet (24) and a fluid outlet (30), having a valve seat (32) around the fluid outlet, having a valve element (34) which can contact the valve seat, so that the fluid outlet is closed, and having a piezoelectric actuator (40), which is provided with an actuation extension (42) that can engage the valve element, a temperature compensation is to be attained at little effort. To that end, it is provided that a displaceable wall part (28) is provided, on which the valve seat is embodied and which defines the pressure chamber on the side of the valve seat, and that a temperature compensation element (44) is provided, which cooperates with the displaceable wall part and displaces it in accordance with a temperature-dictated change in length of the piezoelectric actuator.

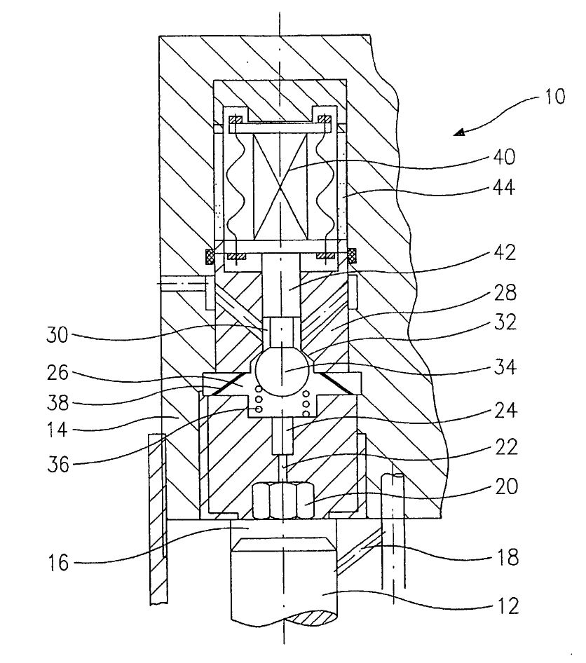

### PRIOR ART

The invention relates to an injection nozzle for a fuel injection system, having a pressure chamber which is provided with a fluid inlet and a fluid outlet, having a valve seat around the fluid outlet, having a valve element which can contact the valve seat, so that the fluid outlet is closed, and having a piezoelectric actuator, which is provided with an actuation extension that can engage the valve element.

The valve element serves to control the opening and closing of a nozzle needle of the injection nozzle. The nozzle needle protrudes into a control chamber, to which a fluid under pressure, in particular fuel, is delivered. From the control chamber, the fluid can flow through an outlet throttle into the pressure chamber. When the fluid outlet out of the pressure chamber is closed, that is, if the valve element is resting on the valve seat, the fluid is dammed up in the control chamber, so that a high pressure builds up there. This pressure keeps the nozzle needle in its closed position. When the nozzle needle is to be opened, the valve element is lifted from the valve seat by actuation of the piezoelectric actuator. As a result, the fluid can flow out of the pressure chamber and the control chamber, so that the pressure in the control chamber drops. As a result, an opening force acting on the nozzle needle, which is generated by the fuel pressure prevailing on the front end of the nozzle needle, is capable of opening the nozzle needle. Fuel can now be injected.

The use of a piezoelectric actuator offers the advantage that with comparatively low electrical power levels and short response times, the valve element can be switched. The disadvantage of a piezoelectric actuator is that the piezoelectric stack contained in it, that is, the stack of individual piezoelectric elements, undergoes a comparatively great increase or decrease in length upon temperature changes.

To prevent this change in length of the piezoelectric actuator from affecting the switching behavior of the injection nozzle, various provisions have been proposed in the prior art serving the purpose of temperature compensation. For instance, from German Patent Disclosure DE 35 33 085 A1, a hydraulic compensation system is known in which a hydraulic piston serves as an abutment for the piezoelectric actuator. The hydraulic piston makes a slow change in length of the piezoelectric actuator possible, because in such a change in length, fluid is positively displaced by the compensation piston through a narrow throttle gap. If conversely a rapid change in length occurs, as in the case of an actuation of a piezoelectric actuator, the compensation piston can be assumed to be sufficiently rigid, since the throttle restriction does not allow a rapid displacement of the compensation piston.

From German Patent Disclosure DE 195 31 652 A1, a compensation system is known in which the piezoelectric actuator is fundamentally freely displaceable, so that it can undergo temperature-dictated changes in length. However, to have an abutment available upon an activation of the piezoelectric actuator, the piezoelectric actuator is fastened in its position at the time by a clamping device immediately before it is activated. This fastening is released again after the activation, so that in the phases of repose of the piezoelectric actuator, a change in length that may be necessary can in fact occur.

The object of the invention is to create a temperature-compensated injection nozzle of simple design that is actuated by a piezoelectric actuator.

Advantages of the Invention

The injection nozzle of the invention, having the characteristics of claim 1, uses a purely mechanical system for temperature compensation, resulting in an especially simple design. In its fundamental concept, the invention is based on adjusting the valve seat in the same way as the actuation extension if a temperature fluctuation occurs, with an attendant change in length of the piezoelectric actuator. In this way, no temperature-dictated relative displacement occurs between the valve seat and the actuation extension, and hence the switching characteristics do not change.

As the temperature compensation element, a sleeve can for instance be used that surrounds the piezoelectric actuator. This produces an especially compact design. Any arbitrary material whose coefficient of thermal expansion is approximately the same as that of the piezoelectric ceramic used for the piezoelectric actuator can be employed for the temperature compensation element.

Advantageous features of the invention will become apparent from the dependent claims.

### DRAWING

The invention is described below with reference to a preferred embodiment, which is shown in the accompanying SOLE drawing. In it, the end of an injection nozzle according to the invention is shown in a cross section, this end being provided with the piezoelectric actuator and the pressure chamber.

### DESCRIPTION OF THE EXEMPLARY EMBODIMENT

In the drawing, a detail of an injection nozzle 10 is shown. It has a nozzle needle 12, which is mounted adjustably in the nozzle body 14. The nozzle needle 12 protrudes into a control chamber 16, which communicates with a fuel inlet 18. From the control chamber 16, a fuel outlet 20 leads away via an outlet throttle 22 to a fluid inlet 24, which discharges into a pressure chamber 26. On its side opposite the fluid inlet 24, the pressure chamber 26 is defined by a wall part 28, which is mounted displaceably in the nozzle body 14. The wall part 28 is provided with a through bore, forming a fluid outlet 30 out of the pressure chamber 26. This fluid outlet can be closed by a valve element 34, which can rest on a valve seat 32 on the wall part 28. For action upon the valve element 34, a prestressing spring 36 is disposed in the pressure chamber 26. Finally, a compression spring 38 in the form of a cup spring is also disposed in the pressure chamber 26; this spring is braced between the wall part 28 and the bottom, opposite it, of the pressure chamber 26.

For actuating the valve element 34, a piezoelectric actuator 40 is provided, which is disposed on the side of the pressure chamber 26 remote from the nozzle needle 12. The piezoelectric actuator 40 is provided with an actuation extension 42, which extends through the fluid outlet 30 and is capable of lifting the valve element 34 from the valve seat 32.

A temperature compensation element 44 in the form of a sleeve is disposed around the piezoelectric actuator 40; with one axial end, it is braced on the bottom of the bore surrounding the piezoelectric actuator 40, and with its other axial end it is braced on the displaceable wall part 28. The temperature compensation element 44 has a coefficient of thermal expansion that is approximately equal to that of the piezoelectric actuator 40.

The piezoelectric actuator 40 serves in a manner known per se, by actuation of the valve element 34, to open the fluid outlet 30 out of the pressure chamber 26 selectively and thus to bring about a drop in the fluid pressure in the control chamber 16, so that the nozzle needle 12 can be opened. If a temperature change and an attendant change in length of the piezoelectric actuator occurs during operation of the injection nozzle, the temperature compensation element 44 experiences the same change in length. The result is a displacement of the displaceable wall part 28 and thus of the valve seat 32 that is equivalent to the displacement of the end of the actuation extension 42 that engages the valve element 34. In this way, a relative displacement between the valve seat 32 and the actuation extension 42 upon a temperature change is prevented, and the switching characteristics of the injection nozzle remain unaffected by temperature changes. Upon an adjustment of the displaceable wall part 28, the compression spring 38 serves to keep this wall part always in contact with the temperature compensation element 44, so that the wall part 28 follows along with a shortening of the temperature compensation element 44 as well. The use of a cup spring offers the advantage that given a suitable design, the same spring force is always furnished, regardless of any displacement of the wall part 28.

1. An injection nozzle (10) for a fuel injection system, having a pressure chamber (26) which is provided with a fluid inlet (24) and a fluid outlet (30), having a valve seat (32) around the fluid outlet, having a valve element (34) which can contact the valve seat, so that the fluid outlet is closed, and having a piezoelectric actuator (40), which is provided with an actuation extension (42) that can engage the valve element, characterized in that a displaceable wall part (28) is provided, on which the valve seat is embodied and which defines the pressure chamber on the side of the valve seat, and that a temperature compensation element (44) is provided, which cooperates with the displaceable wall part and displaces it in accordance with a temperature-dictated change in length of the piezoelectric actuator.

2. The injection nozzle of claim 1, characterized in that the actuation extension (42) of the piezoelectric actuator (40) protrudes through the displaceable wall part (28).

3. The injection nozzle of one of claims 1 and 2, characterized in that the temperature compensation element (44) is a sleeve that surrounds the piezoelectric actuator.

4. The injection nozzle of one of claims 1-3, characterized in that a compression spring (38) is disposed between the displaceable wall part (28) and the opposite wall of the pressure chamber (26).

5. The injection nozzle of claim 4, characterized in that the compression spring (38) is a cup spring.
